(19) United States
(12) Patent Application Publication
(10) Pub. No.: US 2013/0319704 A1
(43) Pub. Date: Dec. 5, 2013

(54) DRIVE UNIT FOR A POWER OPERATED TOOL

(71) Applicants: John K. Junkers, Saddle River, NJ (US); Stefan Werner, Sprockhovel (DE)

(72) Inventors: John K. Junkers, Saddle River, NJ (US); Stefan Werner, Sprockhovel (DE)

(73) Assignees: Hydrower Hydraulik GMBH, Sprockhovel (DE); Hytorc Division Unex Corporation, Mahwah, NJ (US)

(21) Appl. No.: 13/885,845

(22) PCT Filed: Nov. 15, 2010
(86) PCT No.: PCT/US10/56683

§ 371 Date: May 16, 2013

(51) Int. Cl. B25B 23/145

(52) U.S. Cl. CPC B25B 23/145
USPC 173/1; 173/218; 173/20; 81/470

(57) ABSTRACT

The invention relates to a drive unit for a power operated tool for the generation of a screw pretensioning force, with a pump unit (2), a valve unit (3) arranged on the pump unit with a pressure-restricting pressure valve (4) and a control unit (2) for activating the pump unit. In order to provide a drive unit that eliminates the risk of an incorrect setting of the setting parameter, it is provided that a processing unit (5) with an output unit and a data capturing unit (6) connected and/or integrated with the processing unit are provided, wherein the processing unit is designed for the output of the value to be set on the pressure valve based on the screw connection process parameters determined with the data capturing unit.

The invention relates to a drive unit for a power operated tool for the generation of a screw pretensioning force, with
a pump unit,
a valve unit arranged on the pump unit with a pressure-restricting pressure valve and
a control unit for activating the pump unit.

Drive units of the initially named type for driving power operated tools for the generation of a screw pretensioning force, which include for example hydraulically operated impact wrenches or expanding cylinders, have been sufficiently known from the state of the art. Other such power operated tools include those pneumatically, electrically and hydraulically driven. For example, DE 10 2004 058 338 A1 describes an apparatus for the automatic production of individual screw connections by means of an impact wrench, which is driven by a drive unit. An evaluation unit thereby shows when the screw connection to be established with the impact wrench has the required fastening torque and thus reduces the risk of defective screw connections.

The actual screwing process is made up of several work processes, in which a piston cylinder unit driving the impact wrench executes both a load stroke and a return stroke. The piston cylinder unit thereby serves in known impact wrenches for example to drive a ratchet wheel, which is turned by the piston cylinder unit. The volume flow hereby ensures the movement of the piston cylinder unit and the pressure for the force that is transferred to the ratchet wheel for the establishment of a screw connection.

In the case of screw connections established by impact wrenches, a pressure set on a pressure adjusting valve of the drive unit thus determines the torque and the pretensioning force, with which the screw connection is established. The screwing process for the establishment of the screw connection is thereby performed with load strokes with increasing pressure until the pressure set on the pressure adjusting valve has been reached and the screw to be tightened no longer turns at that torque pressure, which means that the screw has been tightened or retightened and/or has been set.

Known drive units, in particular in the case of the use of impact wrenches, now have embodiments, which absolve the operating personnel from the responsibility of deciding whether the screwing process was performed properly. However, it is still required that the operating personnel first set the setting parameters in the prescribed manner so that the target parameters to be achieved can be achieved. The setting parameters, in particular the pressure to be set, thereby conform to a plurality of screw connection process parameters, which result for example from the operator, screw connection and the tool. Known sources of errors, which lead to a defective screw connection, are for example an incorrect selection of tools, incorrect use of calculation tables, basic calculation errors in the determination of setting parameters, incorrect assignment of screw parameters to the screw connection and finally an incorrect setting of the setting parameters.

Based on this, the object of the invention is to provide a drive unit that eliminates the risk of an incorrect setting of the setting parameter.

The invention solves the object through a drive unit with the characteristics of claim 1. Advantageous embodiments of the invention are listed in the dependent claims.

Characteristic for the drive unit according to the invention is that it has a processing unit with an output unit as well as a data capturing unit connected and/or integrated with the processing unit, wherein the processing unit is designed for the output of the value to be set on the pressure valve based on the process parameters determined with the data capturing unit. The data capturing unit of the drive unit according to the invention makes it possible to automatically capture screw connection processing parameters without requiring input from the operating personnel. The screw connection process parameters include for example data on the operating personnel, data on the tool to be used, e.g. the used impact wrench or expanding cylinder, data on the screw connection to be established, information on the screw connection means and data on the structural elements to be screwed together. The saving of the corresponding process parameters in a form in which they can be automatically imported by the data capturing unit permits the error-free capturing of all process parameters required for the determination of the setting parameters, based on which the processing unit determines the setting parameters, insofar as they are not saved or do not already result directly from the imported data. The specification, input and/or use of incorrect setting parameters, which could result from incorrect inputs by operating personnel, is prevented by automated data capturing. The setting parameters determined by the processing unit are specified without error via the output unit of the processing unit, so that only a transfer of the specified setting parameters is required. The work process can then be started via activation of the control unit of the pump unit and can be ended again after the target values have been reached. Automatic systems, which are e.g. integrated into the processing unit and that independently start the work process and end it after the target values have been reached, can also be used to perform the work process.

The balancing of the automatically captured specific process parameters to be performed by the processing unit can generally take place in any manner, wherein for example the data required for determining the setting parameters are already saved in the processing unit. However, in accordance with an advantageous further embodiment of the invention, the processing unit is designed for connection with a storage unit. This embodiment of the invention makes it possible to selectively provide the processing unit with the information necessary for determining the required setting parameters via the storage unit. In the case of this further embodiment of the invention, the saving of the relevant data required for determining the setting parameters in the processing unit can be omitted so that it can be designed particularly cost-effectively.

The connection to a storage unit also enables in a simple manner access to current data so that an otherwise potentially complicated updating of the processing unit can be omitted.

The connection option to the storage unit also makes it possible to save process-specific information, e.g. data on the performed work processes, on the storage unit. A manual, potentially defective and time- and cost-intensive documentation of the performed work processes can be omitted in this case. The establishment of a connection of the processing unit with the storage unit can thereby take place in any form, wherein for example a standardized connection arranged on the processing unit, e.g. a USB connection, enables in a simple manner the connection of the storage unit to the processing unit.

However, according to a particularly advantageous embodiment of the invention, the processing unit is designed for wireless connection with the storage unit. The wireless connection, which can in particular be established via standardized radio protocols, enables a particularly simple and comfortable connection of the processing unit with the storage unit. They can be equipped for example with a GSM module, a Bluetooth module or the like. This embodiment of the invention also makes it possible to access a central storage unit, e.g. a central database, with correspondingly designed drive units, so that local storage units are not needed. The use of a central database facilitates data management in a special manner since updates only need to be made in one database. Moreover, the wireless connection to the central storage unit makes it possible to save information on the performed screwing processes centrally so that information can be queried from the central database by authorized persons, similar to the tracking of product shipments.

For the determination of setting parameters, it is required that the screw connection process parameters are saved in a manner comprehendible by the data capturing unit at a suitable location, e.g. in the tool or the screw connection. The screw connection process parameters may include, e.g. the operating personnel identification; the tool information which includes e.g. information on the manufacturer, type, size, serial number, characteristics; data on the screw connection instances can be type, application, description of the screw connection type, screw connection parameters (e.g. torque, angle of rotation, pretensioning force); and data on the equipment of the screw connection include e.g. manufacturer, thread, dimensions, yield points, etc. Note that screw connection process parameters may include other relevant characteristics, data and/or information. These screw connection process parameters are saved in a manner comprehendible by the data capturing unit on the individual elements. The type of the data saving in a manner comprehendible by the data capturing unit is thereby generally freely selectable. Since e.g. barcodes or RFID units have particularly proven themselves as machine-readable codes, the data capturing unit is designed as a mobile code reader unit and/or RFID receiver and/or write unit according to a particularly advantageous embodiment of the invention.

Such data capturing units are characterized by their high reliability and cost-effective design. If applicable, the respective information is saved in a form corresponding to the data capturing units, i.e. in accordance with this advantageous embodiment as machine-readable code or on an RFID unit, so that it can be captured immediately.

The use of RFID units is thereby characterized in particular in that the capturing can take place in wireless form and over a greater distance, wherein the use of RFID units also makes it possible to save supplementary data on the RFID unit after completion of the work processes. Machine-readable code is thereby understood in particular as barcodes or the like, wherein the read devices then have corresponding scanners. The barcodes can be arranged on stickers, which are e.g. attached to the tool and/or the screw connection.

The connection of the data capturing unit with the processing unit can also generally take place in any manner. However, according to a particularly advantageous embodiment of the invention, the data capturing unit is designed for wireless connection with the processing unit. A corresponding design of the invention, in which the connection is established e.g. via standardized radio procedures, increases ease of use in a supplementary manner since there is no restriction for data capturing via data capturing units due to a cable-bound connection.

The design of the pressure valve for determining the pressure to be applied by the pump unit, e.g. for the establishment of a pretensioning force by means of an expanding cylinder, can generally take place in any manner. However, according to a particularly advantageous embodiment of the invention, the pressure valve is designed as a pressure setting valve restricting the torque pressure. In the case of the use of impact wrenches to establish a screw connection, this design of the invention enables in a particularly simple manner the setting of the torque required for the screw connection. The pressure setting valve can thereby be set in any manner, in the easiest manner by hand, to the value specified on the output unit. The start of the screwing process can then take place via activation of the control unit of the pump unit.

In addition to a purely optical output of the setting parameters via the output unit, it is provided according to a further embodiment of the invention, that the output unit is designed for control and/or regulation of the pressure valve and/or pressure setting valve. In accordance with this embodiment of the invention, the setting parameter determined by the processing unit is automatically transferred to the pressure valve or respectively pressure setting valve, e.g. an electrically controllable pressure setting valve, after determination of the process parameters via the data capturing unit. This embodiment of the invention guarantees in a supplementary manner that a misadjustment caused by operating personnel and thus a defective screw connection do not result. In a particularly advantageous manner, the output unit is also designed to check the setting parameters and to make corrections. This ensures in a particularly reliable manner an error-free establishment of the required screw connections.

The documentation of the performed work processes can generally take place in any manner, for example as listed above, by saving information on a storage unit. However, according to a particularly advantageous embodiment of the invention, the output unit has a printing apparatus, which makes it possible to make available to operating personnel immediately in printed form reports on the realized screw connections. Alternatively or additionally, it can also be provided according to a further development of the invention that the processing unit is designed for the documentation of the realized screw connections. Should it be required to procure information on the realized screw connections, the processing unit can be accessed at a later time and the data saved there can be called.

In accordance with a particularly advantageous embodiment of the invention, the processing unit has a time and/or position capturing unit. This data, wherein the position capturing unit can be formed e.g. by a GPS receiver, can also be saved as information on the realized processes so that the quality of the realized and callable documentation can be increased in a supplementary manner.

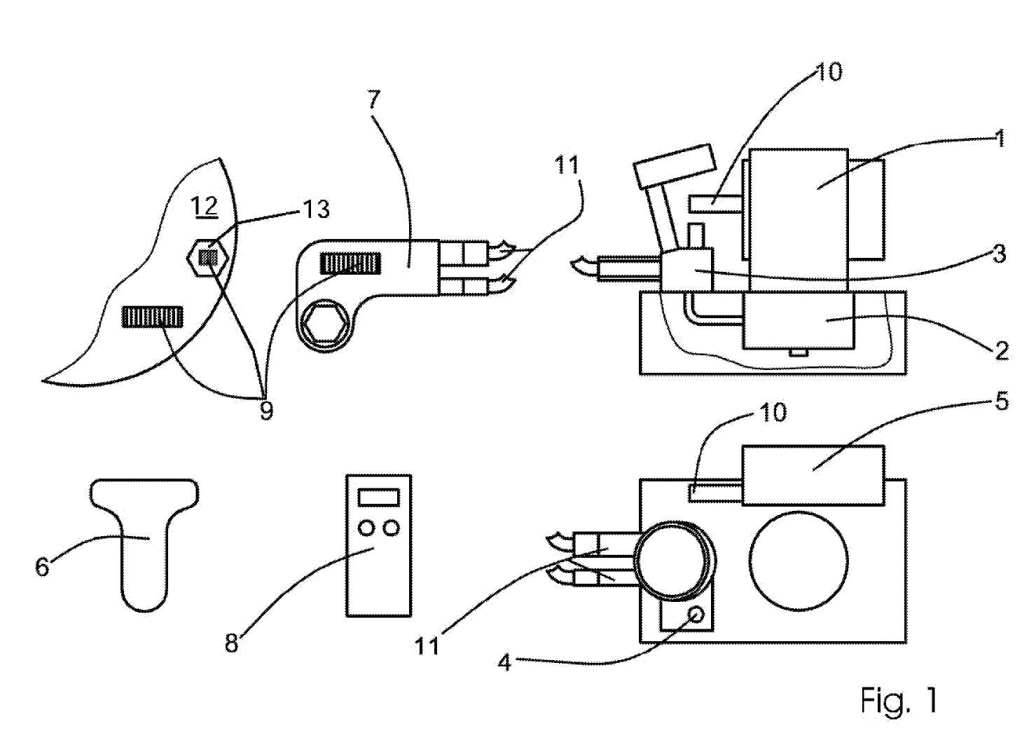

An exemplary embodiment of the invention is explained in great detail below with reference to the drawing. The drawing shows in FIG. 1, a sketch of a view of a drive unit with attached impact wrench.

FIG. 1 shows a perspective representation as a sketch of a drive unit 1. It has a pump unit 2 and a valve unit 3 connected with the pump unit 2, which is designed to connect two hydraulic lines 11, of which one is connected to a load stroke side and one to a return stroke side of an impact wrench 7. In order to set the torque required for a screw connection, the valve unit 3 has a pressure setting valve 4. After capturing by means of a mobile barcode scanner 6 screw connection process parameters (9) from the operating personnel, the tool (7), a screw connection instance or application (12) and screw connection equipment (13), it is transferred wirelessly to a processing unit 5, which indicates the compression torque to be set via the display of a control unit 8 after accessing the data saved on a storage unit 10. After setting the shown compression torque on the pressure setting valve 4 by the operator, the screwing process can be started and stopped via the control unit 8. Note that the compression torque or the screw pretensioning force is the force necessary to tighten and/or loosen the screw connection.

In an alternative embodiment not shown here, the setting of the determined setting parameter on the pressure setting valve 4 takes place directly through forwarding from the processing unit 5 to the pressure setting valve 4. After setting on a preferably electrically controllable pressure setting valve, the screw connection can either be started automatically or initiated by the operator via the activation unit 8. After completion of the screwing process, specific data on the screw connection can be saved on the storage unit 10 by the processing unit 5, where it can be called for later purposes.

In an alternative embodiment not shown here, the control unit 8 may have a sensing unit which determines when the tool 7 is available to tighten and/or loosen the screw connection thereby rendering the valve unit 3 activatable via the control unit 8. The sensing unit acts as a safety mechanism, which helps to prevent injury to the operating personnel. Additionally the control unit 8 and the data capturing device 6 may be combined into one unit, which renders the valve unit 3 to be activatable by the combined unit.

When used in the foregoing specification, and/or the following claims, the terms “comprises”, “includes” and variations thereof mean that the specified features, steps or integers are included. The terms are not to be interpreted to exclude the presence of other features, steps or components. Few if any of the terms or phrases in the specification and claims have been given any special meaning different from their plain language meaning, and therefore the specification is not to be used to define terms in an unduly narrow sense.

The features disclosed in the foregoing specification, the following claims, and/or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. It is to be understood that the above is merely a description of preferred embodiments of the present application and that various changes, combinations, alterations, and variations may be made without departing from the true spirit and scope of the invention as set for in the appended claims.

1. Drive unit for a power operated tool for the generation of a screw pretensioning force, with
a pump unit (2),
a valve unit (3) arranged on the pump unit (2) with a pressure valve (4) restricting the pressure and
a control unit (8) for activating the pump unit (2), characterized by
a processing unit (5) with an output unit and
a data capturing unit (6) connected and/or integrated with the processing unit (5), wherein the processing unit (5) is designed for the output of the value to be set on the pressure valve (4) based on screw connection process parameters (9) determined with the data capturing unit (6).

2. The drive unit according to any preceding claim, characterized in that the processing unit (5) is designed for connection with a storage unit (10).

3. The drive unit according to any preceding claim, characterized in that the processing unit (5) is designed for wireless connection with the storage unit (10).

4. The drive unit according to any preceding claim, characterized in that the data capturing unit (6) is designed as a mobile code reading device (6) and/or RFID receiver and/or write unit.

5. The drive unit according to any preceding claim, characterized in that the data capturing unit (6) is designed for wireless connection with the processing unit (5).

6. The drive unit according to any preceding claim, characterized in that the pressure valve is designed as a pressure setting valve (4) restricting the torque pressure.

7. The drive unit according to any preceding claim, characterized in that the output unit is designed to control and/or regulate the pressure valve and/or pressure setting valve (4).

8. The drive unit according to any preceding claim, characterized in that the output unit has a printing apparatus.

9. The drive unit according to any preceding claim, characterized in that the processing unit (5) is designed for the documentation of the realized screw connections.

10. The drive unit according to any preceding claim, characterized in that the processing unit (5) has a time and/or position capturing unit.

11. The drive unit according to any preceding claim, characterized in that the control unit has a sensing unit which determines when the tool is available to tighten and/or loosen the screw connection thereby rendering the valve unit (3) activatable.

12. The drive unit according to any preceding claim, characterized in that the valve unit (3) is activatable by the data capturing device (6).

13. The drive unit according to any preceding claim, characterized in that the screw pretensioning force is the force necessary to tighten and/or loosen the screw connection.

14. The drive unit according to any preceding claim, characterized in that the screw connection process parameters are determined from an operating personnel, a power operated tool (7), a screw connection instance (12) and screw connection equipment (13).

15. A method of automatically determining a screw pretensioning force for a screw connection process includes
acquiring by means of a data capturing unit (6) screw connection process parameters (9) from an operating personnel, a power operated tool (7), a screw connection instance (12) and screw connection equipment (13),
transmitting the parameters (9) to a processing unit (5) of a control unit (8) of a drive unit (1),
processing the parameters (9) with data saved on a storage unit (10), and
setting the screw pretensioning force on a pressure valve (4) of the drive unit (1).

16. The method according to claim 15, characterized in that the screw pretensioning force is the force necessary to tighten and/or loosen the screw connection.

17. A method of automatically tightening and/or loosening a screw connection includes
acquiring by means of a data capturing unit (6) screw connection process parameters (9) from an operating personnel, a power operated tool (7), a screw connection instance (12) and screw connection equipment (13),
transmitting the parameters (9) to a processing unit (5) of a control unit (8) of a drive unit (1),
processing the parameters (9) with data saved on a storage unit (10),
setting the screw pretensioning force on a pressure valve (4) of the drive unit (1),
determining whether the tool (7) is available to tighten and/or loosen the screw connection,
activating the drive unit (1).

18. The method according to claim 17, characterized in that the screw pretensioning force is the force necessary to tighten and/or loosen the screw connection.

19. An apparatus for managing a threaded fastener substantially as hereinbefore described with reference to and/or as shown in the accompanying drawings.

20. Any novel feature or novel combination of features described herein with reference to and/or as shown in the accompanying drawings.
